(19) United States
(12) Patent Application Publication
(10) Pub. No.: US 2014/0174268 A1
(43) Pub. Date: Jun. 26, 2014

(54) CUTTING APPARATUS

(71) Applicant: Massimiliano Sale, Sasso Marconi (IT)

(72) Inventor: Massimiliano Sale, Sasso Marconi (IT)

(73) Assignee: KEMET ELECTRONICS ITALIA S.R.L., Sasso Marconi (IT)

(21) Appl. No.: 13/983,689

(22) PCT Filed: Feb. 7, 2012
(86) PCT No.: PCT/IB2012/050554

§ 371 Date: Oct. 21, 2013

(30) Foreign Application Priority Data
Feb. 17, 2011 (IT) MO2011A000034

(51) Int. Cl. B26D 1/60; B26D 5/02; B26D 5/20

(52) U.S. Cl. CPC B26D 1/60; B26D 5/20; B26D 5/02
USPC 83/37; 83/318; 83/320

(57) ABSTRACT

In a cutting apparatus, a continuous element with a row of electrochemical cells for lithium batteries is supplied along a supply path on which there are sequentially arranged, a cutting device and two dragging devices, each having a shuttle element that has an operating unit associated with the continuous element.

### BACKGROUND OF THE INVENTION

The invention relates to a cutting apparatus, in particular for cutting flat elements.

In particular, reference is made to a cutting apparatus that may be suitable for cutting, in preset positions, a continuous flat element, for example in the form of a continuous ribbon or film unwound from a reel.

Specifically, but not exclusively, the invention may be used for cutting part of the outline of flat elements (electrodes) that are usable for producing packs of electrochemical cells for forming batteries (for example, lithium batteries).

A cutting apparatus is known in which a continuous element, comprising a row of electrochemical cells with flat electrodes, is supplied with intermittent motion to a cutting device, provided with a punch and die that open and close intermittently with cutting motion coordinated with the intermittent advancing motion of the continuous element, to form the terminals that give rise to the electrical contacts of the battery; at each cutting cycle, the continuous element makes a stop in the intermittent advancing motion thereof, during which the punch and die close to cut a portion of continuous element of length that is equal to a step, to then open and enable the continuous element to advance by a step and then resume a new cutting cycle.

A cutting apparatus is also known in which a flat and continuous element to be cut advances with continuous motion, passing through a cutting device that, in addition to the opening and closing cutting motion, has a reciprocating outward and return motion (parallel to the continuous advancing motion of the continuous element) in which in the outward stroke it is closed in the cutting position, dragging the continuous element forwards, and in the return stroke it is in the opening position; downstream of the cutting device a gripper dragging device is arranged which also has reciprocating outward and return motion, in which in the outward stroke it is closed in the dragging position and in the return stroke it is open; the cutting device and the dragging device are coordinated with one another, such that whilst the one advances the other goes backwards, and vice versa, in order to drag the continuous element with continuous advancing motion.

The precision of the operation of cutting at least one part of the surround of the electrochemical cells is fundamental for obtaining a good-quality reliable and safe battery. One of the problems of the prior art is to reach a valid compromise between quality and productivity when performing the operation of cutting the cells.

### SUMMARY OF THE INVENTION

One object of the invention is to provide a cutting apparatus for cutting a continuous flat element, for example in the form of a continuous ribbon or film.

One advantage is to provide a cutting apparatus that is suitable for cutting a flat element that advances with continuous advancing motion.

One advantage is to enable cutting of predefined zones of the surround of a continuous flat element that is movable along an advancing path.

One advantage is to make a cutting apparatus with high productivity for cutting part of the surround of electrochemical cells for batteries.

One advantage is to make a cutting apparatus available that is able to cut a part of the surround of electrochemical cells in a precise manner.

One advantage is to give rise to a cutting apparatus that is constructionally simple and cheap.

One advantage is to provide an apparatus that enables the terminals of electrochemical cells to be cut that are arranged in a row on a continuous element, which terminals will form the electric contacts of a battery.

Such objects and advantages, and also others, are achieved by the cutting apparatus of one of the claims disclosed below.

### BRIEF DESCRIPTION OF THE DRAWINGS

The invention can be better understood and implemented with reference to the attached drawings, which illustrate a non-limiting embodiment thereof.

FIG. 1 shows, in perspective view, a cutting apparatus for cutting part of the outline of electrochemical cells for lithium batteries.

FIG. 2 is a top plan view of the apparatus in FIG. 1.

FIG. 3 is a side view of the lower side of FIG. 2.

FIGS. 4 and 5 show a dragging device, respectively in an open and in a closed configuration.

FIGS. 6 to 9 show four operating configurations that the apparatus in FIG. 1 adopts in sequence during a work cycle.

FIGS. 10 and 11 show the cutting device, respectively in an open and in a closed configuration.

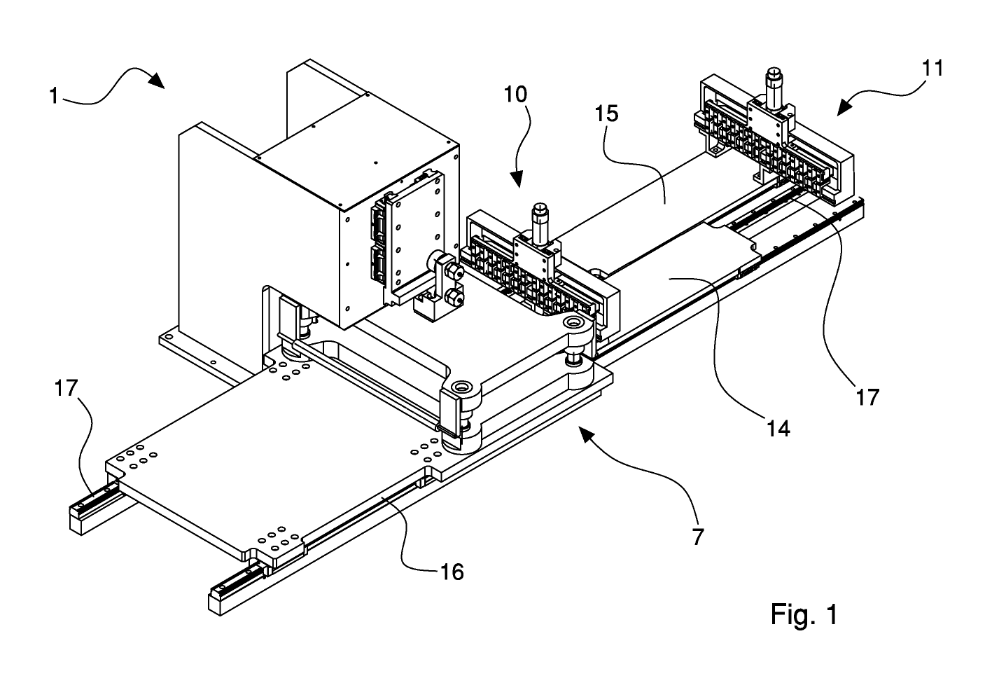

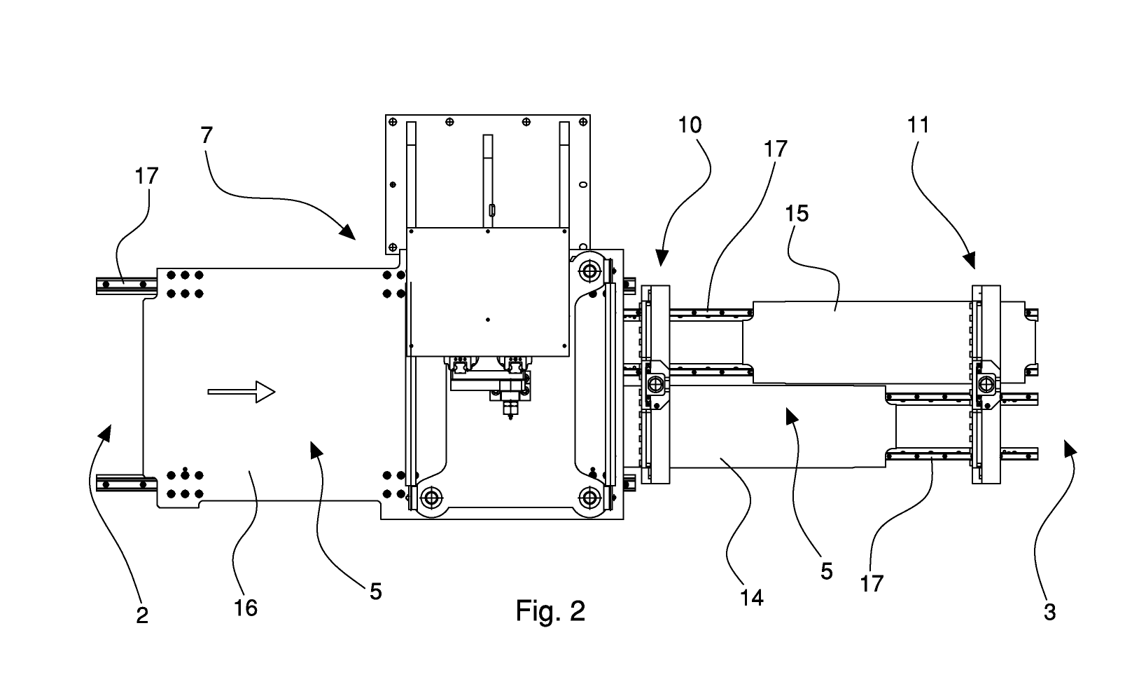

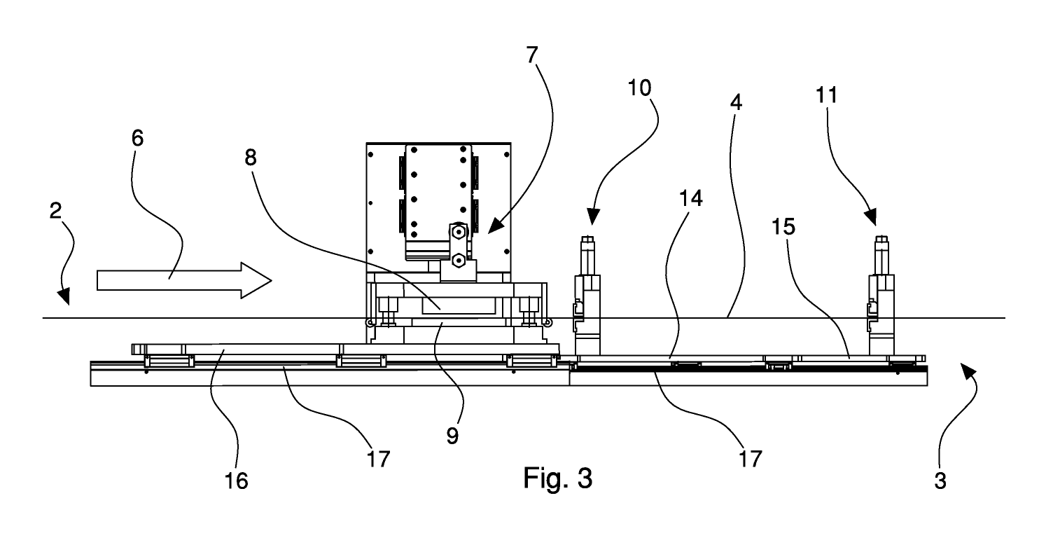

### DETAILED DESCRIPTION

With reference to the aforesaid figures, with 1 a cutting apparatus has been indicated overall, in particular for cutting a continuous and flat element (for example in the form of a ribbon) that advances with a continuous advancing motion. In the specific case the cutting apparatus 1 is configured for cutting a part of the outline of electrochemical cells (for example for lithium batteries) arranged in a row for forming a continuous element. In particular, the cutting apparatus may be used to cut the terminals of the electrochemical cells, which will form the electrical contacts of the assembled battery.

The cutting apparatus 1 may operate, as in the specific case, for cutting preset zones of the continuous element (for example the terminals of electrochemical cells arranged in a row on the continuous element) in such a manner that the continuity of this element is preserved.

The cutting apparatus 1 may be part of a machine for producing electrochemical cells for forming batteries (for example lithium batteries). In this case the cutting apparatus 1 may be operationally associated with a supply device (of known and non-illustrated type) arranged upstream of the cutting apparatus 1 to supply continuously, to an inlet 2 of the cutting apparatus 1, a continuous element, for example a continuous ribbon comprising a row of electrochemical cells. The continuous element may be, for example, unwound from one or more reels. The cutting apparatus 1 may be further combined with a removing device (of known and non-illustrated type) arranged downstream of the cutting apparatus 1 for removing continuously from an outlet 3 of the cutting apparatus 1 the continuous element that has been subjected to the cutting operation. The removing device may comprise, for example, a system for accumulating the continuous element after cutting, which may operate, for example, for rewinding the already cut continuous element on one or more reels.

With 4, the continuous element has been indicated that advances with continuous motion along a supply path 5, inside the cutting apparatus 1, in an advancing direction 6 from the inlet 2 to the outlet 3. The supply path 5 may be configured, in particular, for the advance of a continuous flat element, for example in the form of a ribbon or strip.

The cutting apparatus 1 comprises a cutting device 7 arranged along the supply path 5 of the continuous element 4. The cutting device 7 may be configured, in particular, for cutting a part of the surround of the electrochemical cells of the continuous element 4, for example in order to obtain at least the terminals (for example in the form of tabs) which, after the battery has been assembled, will form the positive and negative electrical contacts of the battery.

The cutting device 7 may be configured to cut in set positions the continuous element 4 by means of a pair of cutting tools (for example a cutting punch 8 and die 9) that are reciprocally movable in a direction that is transverse (for example normal) to the advancing direction 6 of the continuous element 4. In the specific case, the advancing direction 6 is horizontal and the opening and closing position of the cutting tools (punch 8 and die 9) is vertical.

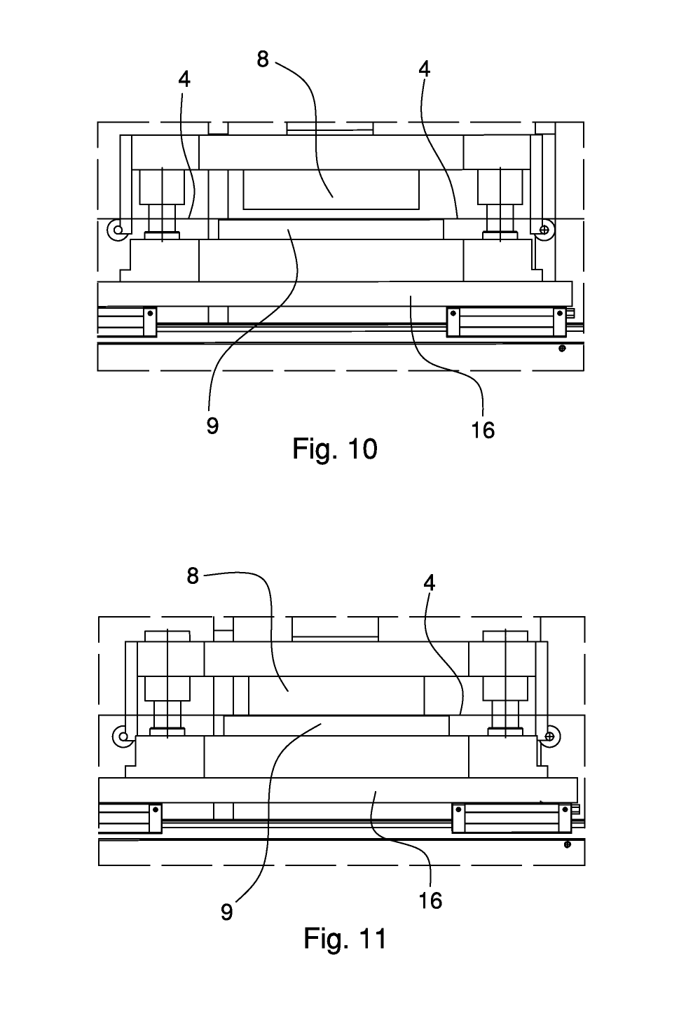

The cutting device 7 is configured for performing a reciprocating outward and return movement between two positions along the (horizontal) path of the continuous element 4. The cutting device 7 may adopt a closed cutting configuration (see FIG. 11) during at least one part of the outward stroke and an inactive open configuration (see FIG. 10) during the return stroke. The transition between the open position (inactive and non-cutting position, in particular position of non-interference with the continuous element 4) and closed (active cutting) position will comprise a movement of at least one cutting tool (cutting punch 8 and/or die 9) in a direction that is transverse to the advancing direction 6 of the continuous element 4 along the supply path 5. The cutting device 7 is movable, upon command of motor means (for example controlled by an electronic control unit), with outward stroke and return stroke, in a direction that is parallel to the advancing direction 6. The cutting device 7 will be controlled in such a manner as to adopt the closed cutting configuration during at least a portion of the outward stroke, and the open non-cutting configuration during the return stroke. The non-cutting configuration (non-interference with the element 6) may be adopted, in particular, also in an initial (acceleration) portion and in a final (deceleration) portion of the outward stroke.

The cutting apparatus 1 further comprises a first dragging device 10 and a second dragging device 11, which are arranged along the supply path 5, downstream of the cutting device 7 (with reference to the advancing direction 6). The second dragging device 11 is arranged downstream of the first dragging device 10 (still with reference to the advancing direction 6).

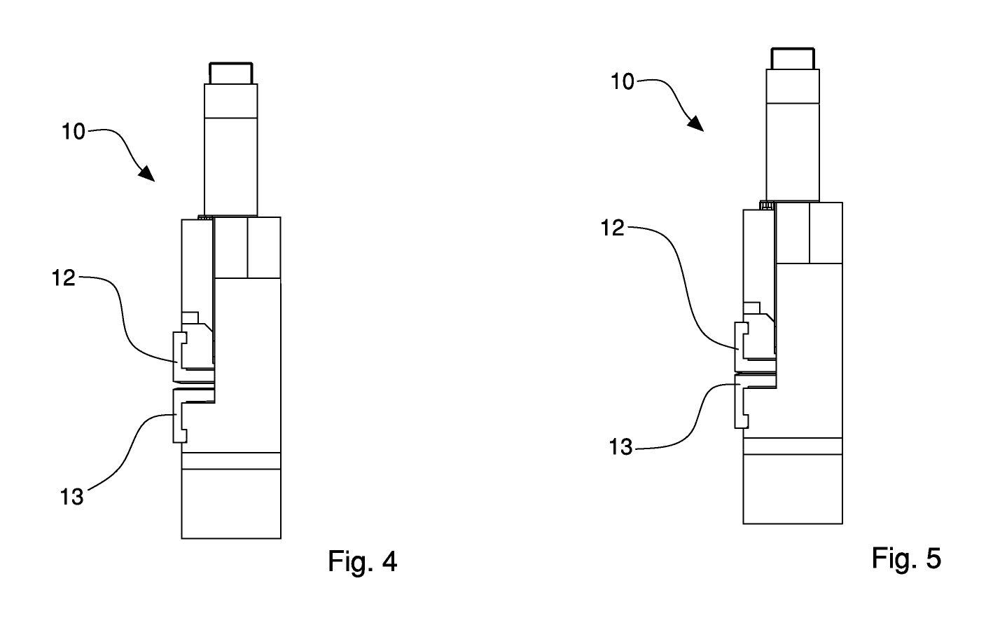

The first dragging device 10 and the second dragging device 11 each have two opposite gripping tools of the gripper type, for example an upper gripping tool or jaw 12 and a lower gripping tool or jaw 13. The gripping tools 12 and 13 are configured for adopting a gripping configuration (FIG. 5), 3 in which they are closed to grip the element 4 that advances along the supply path 5, and a non-gripping configuration (FIG. 4), in which they are open so as not to interfere with the element 4 that advances along the supply path 5. It is possible to envisage that one of the gripping tools 12 and 13, or the other, or both, are moved (in a vertical direction), alternating and moving away from the other tool, to open and close.

The first dragging device 10 comprises a shuttle element 14 (for example comprising a slide) bearing the gripping tools 12 and 13. The second dragging device 11 comprises a shuttle element 15 (for example comprising a slide) bearing the gripping tools 12 and 13. The cutting device 7 comprises a shuttle element 16 (for example comprising a slide) having the cutting tools 8 and 9. Each shuttle element 14, 15 and 16 may perform a reciprocating motion (between two end or stroke limit positions) with an outward stroke and a return stroke. Each shuttle element 14, 15 and 16 is slidable (at the command of motor means) on one or more linear guides 17, each parallel to the advancing direction 6. In the specific case three distinct linear guides 17 are present, one for each shuttle element 14, 15, 16. It is possible to set up two sliding guides, one of which is arranged in common between two of the shuttle elements 14, 15, 16, or even a single sliding guide arranged in common all three shuttle elements 14, 15, 16.

The first dragging device 10 and the second dragging device 11 are each configured, to perform a reciprocating movement, with an outward stroke and return stroke, in a direction that is parallel to the advancing direction 6. Each dragging device 10 and 11 will be controlled, by the aforesaid electronic control unit, to adopt the gripping configuration during at least one part of the outward stroke, in such a manner as to advance the element 4 along the supply path 5, and the non-gripping configuration during the return stroke, to go back without interfering with the element 6 and thus be able to recover the element 4 in the subsequent cycle. The non-gripping configuration (non-interference with the element 6) may be adopted, in particular, also in an initial (acceleration) portion and in a final (deceleration) portion of the outward stroke, for each dragging device 10 and 11.

The first and the second dragging device 11 and 12 are coordinated in such a manner that whilst one of them performs the outward stroke to advance the element 4, the other performs the return stroke, and vice versa, enabling the grip of the element 4 to move from one dragging device to the other without stopping the element 4, in order to enable the element 4 to advance with a continuous motion along the supply path 5. At each transfer of the element 4 from one device 10 or 11 to the other, there will be a relatively short time, in which the continuous element 4 is maintained gripped by both the dragging devices 10 and 11.

In particular, for each dragging device 10 and 11, the outward stroke may comprise an initial acceleration portion, a constant speed central portion and a final deceleration portion. Similarly, the return stroke may possibly comprise an initial acceleration portion, a constant speed central portion and a final deceleration portion. The gripping configuration will be adopted, in particular, in the entire constant speed central portion of the outward stroke, or at least in a part thereof.

Each dragging device 10 and 11 may be driven (for example by programming the electronic control unit) such that the duration of the central portion at constant speed is greater than the duration of the initial portion and the duration of the final portion.

The cutting device 7 may be driven (for example by programming the electronic control unit) in such a manner that the outward stroke thereof comprises an initial acceleration portion, a constant speed central portion and a final deceleration. Similarly, the return stroke may possibly comprise an initial acceleration portion, a constant speed central portion and a final deceleration portion. The cutting configuration will be adopted, in particular, in the entire constant speed central portion of the outward stroke, or at least in a part thereof.

For each of the cutting or dragging devices, indicated above with 7, 10 and 11, the average speed of the return stroke may be greater than the average speed of the outward stroke, and the length of the outward stroke may be, for example, the same as the length of the return stroke.

The cutting device 7 and the first dragging device are coordinated together (for example by means of the electronic control unit) such that the speed of the cutting device 7 in the aforesaid active cutting portion of the outward stroke, in which the cutting tools are closed, is constant and the same as a constant speed that the first dragging device 10 maintains during at least one active (central) dragging portion of the outward stroke thereof, during which the gripping tools are also in the closed configuration. In this manner, when the cutting tools and the gripping tools are simultaneously active in relation to the continuous element 4, the risk of damage, breakage or deformation of the element is reduced, inasmuch as all the (gripping or cutting) tools that are active on the element 4 advance at the same (constant) speed.

Similarly, the cutting device 7 and the second dragging device 11 may be coordinated together (for example by the electronic control unit), such that the speed of the cutting device 7 in the aforesaid active cutting portion of the outward stroke, in which the cutting tools are closed, is constant and the same as a constant speed that the second dragging device 11 maintains during at least an active (central) gripping portion of the outward stroke thereof, during which the gripping tools of the second dragging device 11 are also in the closed configuration.

During operation, the two dragging devices 10 and advance the continuous element 4 continuously, in particular at a constant speed, in the advancing direction 6 along the path 5, without making any cut, alternating in dragging the element 4 forwards, whilst the cutting device 7 will cut the element 4 in the desired positions, so the dragging function is performed exclusively by the dragging devices 10 and 11, whilst the cutting function is performed exclusively by the cutting device 7.

More in particular, the first dragging device 10 performs a sequence of first dragging cycles, each comprising an outward stroke (with at least one portion in the gripping configuration) and a return stroke (in the non-interference configuration), the second dragging device 11 simultaneously performs (in a preset phase relation with the first dragging device 10), a sequence of second dragging cycles, each comprising an outward stroke (with at least one portion in the gripping configuration) and a return stroke (in the non-interference configuration), and the cutting device 7 performs a sequence of cutting cycles each comprising an outward stroke (with at least one portion in the cutting configuration) and a return stroke (in the non-interference configuration).

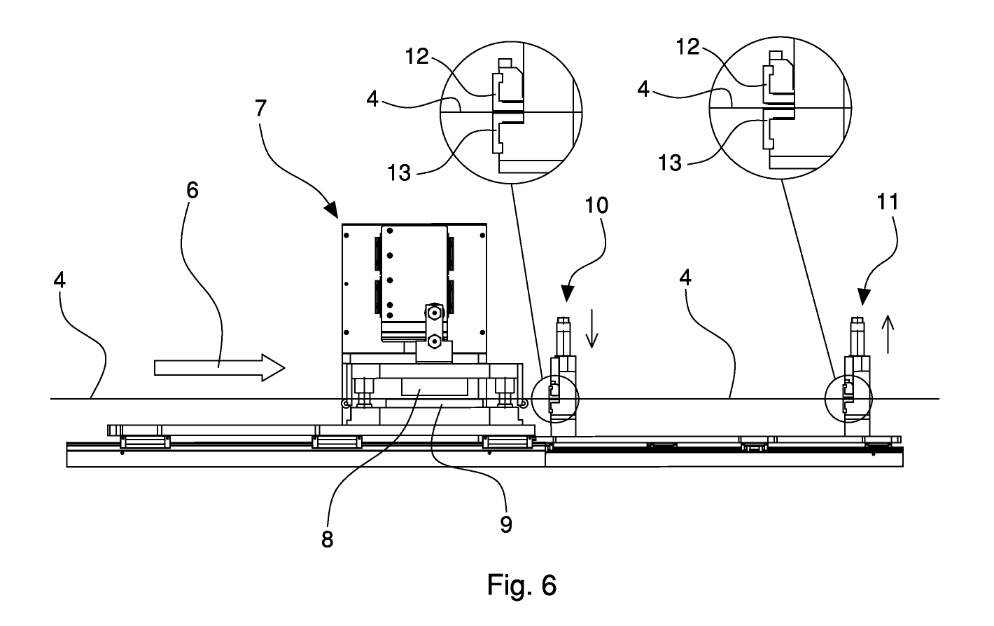

The dragging cycles of the devices 10 and 11, and the implementation thereof, are illustrated in greater detail in FIGS. 6 to 9.

In a first step (FIG. 6), the first dragging device 10, which is in an initial portion of the outward stroke (retracted position) thereof, closes to grip the element 4; the gripping of the element 4 by the first dragging device 10 will in particular occur when this device 10, during the advancing motion (outward stroke) thereof, has already finished the initial acceleration step and has just started the constant speed central step; when the element 4 is already gripped by the first dragging device 10, the second dragging device 11, which is in a final portion of the outward stroke (advanced position) thereof, in the gripping configuration, opens; the release of the gripping of the element 4 by the second dragging device 11 will in particular occur when this device 11, in the advancing motion (outward stroke) thereof, has not yet started the final deceleration step and is finishing the constant speed central step.

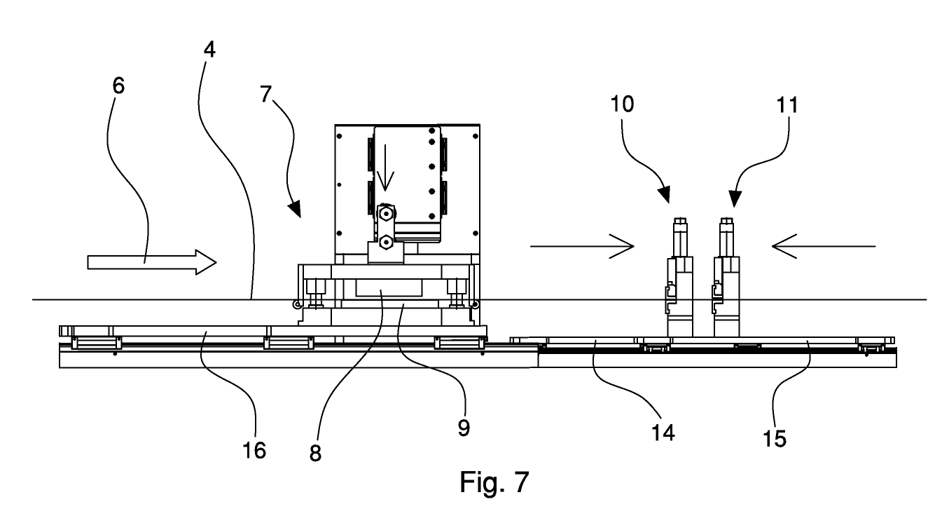

In a second step (FIG. 7), the first dragging device 10 advances (central part of the outward stroke), in particular at a constant speed, whilst the second dragging device 11 retracts (return stroke).

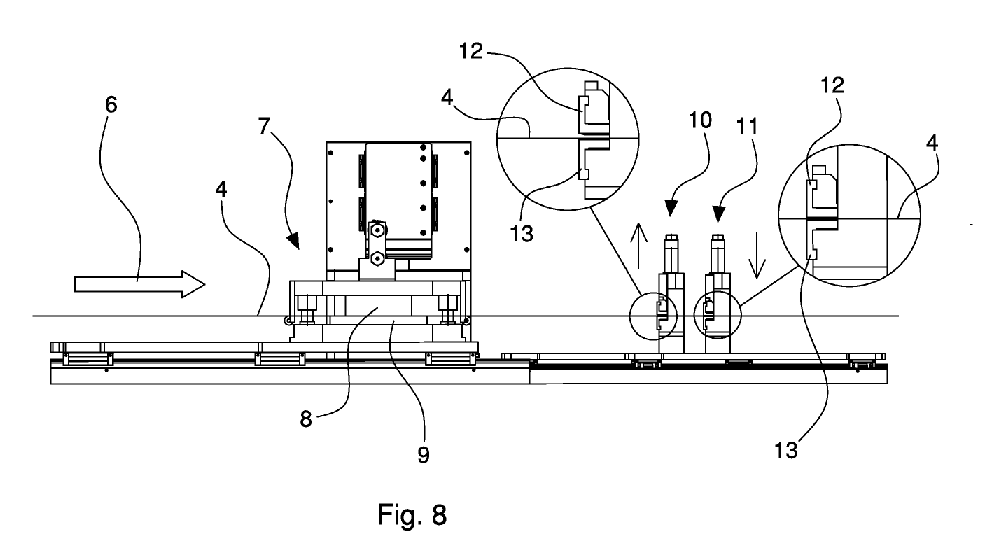

In a third step (FIG. 8), the second dragging device 11, after terminating the return stroke and being in the initial portion of outward stroke (retracted position) thereof, closes to grip the element 4; the gripping of the element 4 by the second dragging device 11 will in particular occur when this device 11, in the advancing motion (outward stroke), has already finished the initial acceleration step and has just started the constant speed central step; when the element 4 is already grasped by the second dragging device 11, then the first dragging device 10, which is in a final portion of the outward stroke (advanced position) in the gripping configuration, opens; the release of the gripping of the element 4 by the first dragging device 10 will in particular occur when this device 10, in the advancing motion (outward stroke) thereof, has not yet started the final deceleration step and is finishing the constant speed central step.

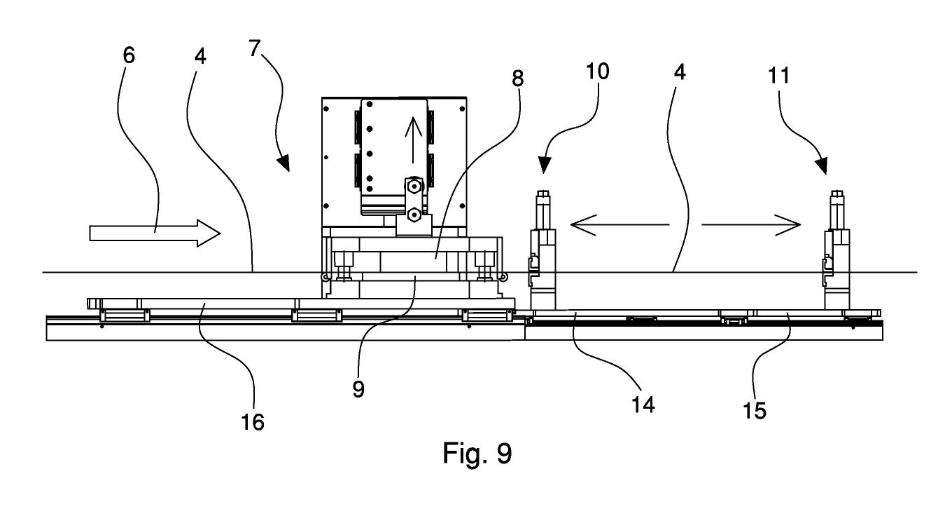

In a fourth step (FIG. 9), the second dragging device 11 advances (central part of the outward stroke), whilst the first dragging device 10 retreats (return stroke), until the return stroke is completed and the outward stroke is resumed. After this, the dragging cycle starts again from the first step (FIG. 6).

During the dragging cycle, the cutting device 7 performs the cutting cycle (at a frequency that is not necessarily the same as the dragging cycle, but also different and independent from the latter). In a first step, the cutting device 7, which is in an initial portion of the outward stroke (retracted position, as for example in the FIG. 7) thereof, closes to cut a first portion of the element 4. In a second step, the cutting device 7, which is in a final portion of the outward stroke (advanced position, FIG. 9) thereof in a cutting configuration, opens. Then the cutting device 7 concludes the outward stroke and starts the return stroke (which is on average faster than the outward stroke), still in the open non-interference configuration. At this point, the cutting device 7 closes the cutting cycle, returning to the initial portion of the outward stroke (retracted position), in which it closes to cut a second portion of element 4, starting the second cutting cycle. The cutting device 7 will be coordinated with the advance of the element 4, such that each portion of element 4 processed in a cutting cycle, is subsequent to and immediately contiguous to the portion of element 4 processed in the preceding cutting cycle.

The time for executing the cutting cycle (outward and return strokes) may be different, in particular less, than the performance time of the first dragging cycle (outward and return strokes) of the first dragging device 10 and the time for executing the second dragging cycle (outward and return strokes) of the second dragging device 11. The cutting cycle time is detached from the times of the dragging cycles. The cutting cycle may last for the minimum time required to perform effective and reliable cutting, as the cutting device is dedicated exclusively to cutting and does not advance the continuous element 4. Similarly, also the extent of the cutting stroke is independent of the extent of the strokes of the dragging devices.

The execution time of the dragging cycle of the first dragging device 10 may be the same as the execution time of the dragging cycle of the second dragging device 11.

The length of the outward stroke of the cutting device 7 may be different, in particular less, than the length of the outward stroke of the first dragging device 10. The length of the outward stroke of the cutting device 7 may be different, in particular less, than the length of the outward stroke of the second dragging device 11.

As said, each dragging device 10 and 11 and cutting device 7 may perform an outward stroke with an initial acceleration portion, a constant speed central portion and a final deceleration portion. For each device 7, 10 and 11 the duration of the central portion may be greater than the duration of the initial portion and of the duration of the final portion. For each device 7, 10 and 11 the average speed of the return stroke may be greater than the average speed of the outward stroke. For each device 7, 10 and 11 the length of the outward stroke may be same as the length of the return stroke.

The first and the second dragging device 10 and 11 may be coordinated together (for example by programming the electronic control unit) in such a manner as each to have at least one part of the outward stroke (the central portion) thereof at a speed that is constant and the same as the constant speed of the other dragging device, in order to advance the continuous element 4 at a constant speed along the supply path 5.

The apparatus may be provided with a system for collecting chippings comprising, for example, one or more chippings collecting hoppers that may be arranged under the cutting device 7.

The cutting device 7 may cut, during each outward cutting stoke, the electric terminals of a group of cells (formed of one or more cells) at a time and may turn back so as to restart the subsequent cutting stroke without leaving any cell uncut between two consecutive cutting zones.

The cutting apparatus will comprise, as said, an (electronic) control unit programmed to control the various actuators of the apparatus (in particular, the dragging devices and the cutting device) according to the operating method disclosed above.

It is observed that the frequency of the cutting cycle with which the cutting device 7 operates on the element 4 is independent of the frequency of the dragging cycles of the devices 10 and 11. Further, also the extent of the reciprocating movement of the cutting device 7 (outward and return stroke) is independent of the extent of the reciprocating movements (outward and return strokes) of the dragging devices 10 and 11.

1-11. (canceled)

12. A cutting apparatus comprising
(a) a supply path along which a continuous element advances in an advancing direction;
(b) a cutting device arranged in said supply path, said cutting device being configured to perform a reciprocating movement with an outward stroke and a return stroke in a direction parallel to said advancing direction, said cutting device being configured for cutting the element during at least one active portion of the outward stroke and for not cutting the element during the return stroke; and
(c) two driving devices sequentially arranged in said supply path, after said cutting device, each of said driving devices being configured to perform a reciprocating movement with an outward stroke and return stroke in a direction parallel to said advancing direction, each of said driving devices being configured to drive the element during at least one active portion of the outward stroke, and not to drive the element during the return stroke, said two driving devices being coordinated together such that, while one of them performs the outward stroke to drive the element, the other performs the return stroke, and vice versa, to advance the element with continuous movement along said supply path.

13. A cutting apparatus according to claim 12, wherein
(a) said cutting device has two opposite cutting tools, which are configured for assuming a cutting configuration, in which they are closed to cut the element arranged in said supply path, and a non-cutting configuration, in which they are open in order not to interfere with the element arranged in said supply path; and
(b) each of said two driving devices has two opposite gripping tools configured for assuming a gripping configuration in which they are closed to grip the element arranged in said supply path during the outward stroke to advance the element along said supply path, and a non-gripping configuration during the return stroke, in which they are opened in order not to interfere with the element arranged in said supply path.

14. A cutting apparatus according to claim 13, wherein each of said two driving devices comprises at least one shuttle element bearing said two gripping tools, and wherein said cutting device comprises one shuttle element bearing said two opposite cutting tools.

15. A cutting apparatus according to claim 12, wherein said cutting device and at least one of said two driving devices are coordinated together such that the speed of said cutting device, during said at least one active portion of the outward stroke, is constant and equal to a constant speed that maintains said at least one of said two driving devices during at least one active gripping part of the outward stroke thereof.

16. A cutting apparatus according to claim 15, wherein said cutting device and the other of said two driving devices are coordinated together so that the speed of said cutting device, during said at least one active portion of the outward stroke, is constant and equal to a constant speed that maintains said other of said two driving devices during at least one active gripping configuration of the outward stroke thereof.

17. A cutting apparatus according to claim 12, wherein each of said two driving devices performs a driving cycle comprising an outward stroke and a return stroke, and said cutting device performs a cutting cycle comprising an outward stroke and a return stroke, the execution time of said cutting cycle being less than the execution time of each of the driving cycles of said two driving devices, and the execution times of the driving cycles of said two driving devices are the same.

18. A cutting apparatus according to claim 12, wherein the length of the outward stroke of the cutting device is less than the length of the outward stroke of at least one of the two driving devices.

19. A cutting apparatus according to claim 12, wherein, for each of said two driving devices and of said cutting device
(1) the outward stroke comprises an initial acceleration portion, a central portion at constant speed and a final deceleration portion that are such that the duration of said central portion is greater than the duration of said initial and final portions; and
(2) the average speed of the return stroke is greater than the average speed of the outward stroke and the length of the outward stroke is the same as the length of the return stroke.

20. An apparatus according to claim 12, wherein said two driving devices are coordinated together so that each has at least one part of the outward stroke thereof at a speed that is constant and equal to the constant speed of the other driving device, and in order to advance the element at a constant speed along said supplying path.

21. A method for using a cutting apparatus according to claim 12, for cutting the electric terminals of electrochemical cells arranged in a row on a flat continuous element.

22. A machine for the production of electrochemical cells, comprising a cutting apparatus according to claim 12.
